(19) United States
(12) Patent Application Publication
(10) Pub. No.: US 2005/0165892 A1
(43) Pub. Date: Jul. 28, 2005

(54) Process to prevent the sending of unwanted e-mail (SPAM)

(76) Inventor: Michael Bryan Kelly, Safety Harbor, FL (US)

Correspondence Address: Michael Bryan Kelly, 215 Woodland Ct, Safety Harbor, FL, 34695, US

(21) Appl. No.: 10/667,984

(22) Filed: Jan. 8, 2004

(51) Int. Cl. G06F 15/16; G06F 15/173

(52) U.S. Cl. 709/205; 709/224

(57) ABSTRACT

A process to reduce the total amount of spam being sent as opposed to processes to manage spam sent and received. A company is formed to establish and maintain a database of email addresses. E-mail address owners that wish to avoid spam may apply to be added to the database and become clients. When a client receives spam, they may notify the company. The company may notify a selected list of clients of the spam event. These notified clients may advise the spammer of the company, the database, and its client's desires. When the spammer has received sufficient notification, the spammer will remove the client list from their list of addresses.

### CROSS-REFERENCE TO RELATED APPLICATIONS

Not Applicable

### FEDERALLY SPONSORED RESEARCH OR DEVELOPMENT

Not Applicable

### SEQUENCE LISTING OR PROGRAM

Not Applicable

### DEFINITIONS

Spam: A colloquial term for unwanted email. Most recipients consider Spam an expensive nuisance.

Spammer: An entity (business, person, etc) that sends unsolicited email.

Company: For brevity, the single word company is defined to reference an entity that is operating under the concepts provided in this application. The company implements these procedures.

Client: An individual, business or other entity that owns an email address and prefers to not receive unsolicited email.

Address pattern: The definition of a group of addresses that a client may wish to enroll. For example, the CEO of Ace Inc. manufacturing may desire to enroll his entire company as a client without enrolling each individual address within Ace Inc. The CEO might request that all addresses of the form xxx@ace.com be enrolled as clients. Any email address that contains the characters “ace.com” will be considered a client.

Database: A collection of information. It may be organized via some type of management utility, by location within a file, or it may not be organized in any manner.

Do not spam request: A do not spam request is a notification to a spammer. The request advises the spammer of the company, the company's purpose, and the company's client list. The request asks that the spammer not spam any clients of the company. The request provides the spammer with sufficient information to remove all members of the client list from the spammer's email address list. The request may be delivered via the most effective method as determined by the sender of the request. The list of methods includes by email and by telephone. The request shall always be courteous and shall always delivered in a respectful manner.

### BACKGROUND OF THE INVENTION

Spam has become a major problem within the Internet community. Estimates of spam traffic have been seen that include the ranges of 20% to 50% of all the Internet traffic. The clear majority of recipients do not want spam. Spam costs business many millions of dollars every year in resources consumed and worker time lost to dealing with spam.

This invention was prompted by the reluctance of spammers to ignore the requests from the general public to not send spam. Indeed, when a spammer receives such a request from any given address, the spammer almost invariably ignores the request. In fact, the request verifies that the spammer has found a valid email address. The spammer will often add that address to a list of known good addresses. This list is then sold to other spammers. The result is that the request to cease spamming not only fails to accomplish its purpose, it results in an ever-increasing load of spam being sent to said address. The individual members of the general public do not have the means to deal with the spamming problem.

Governmental agencies are now considering laws regulating spam. The problem is that the Internet knows few boundaries. If the United States has a law about spamming, a spammer in another country may not be obligated to comply with that law. Spamming laws are expected to be ineffective.

This process invention will enable a company to organize a significant number of members of the general public. Those members acting as a team will be able to convince spammers to curtail their activities. The processes to accomplish this are described in this application.

### BACKGROUND OF THE INVENTION, FIELD OF THE INVENTION

This invention is in the field of electronic mail (email).

### BACKGROUND OF THE INVENTION, DESCRIPTION OF PRIOR ART

Interesting prior art has been found in U.S. Pat. No. 6,643,686 to Hall, Nov. 4, 2003. This is actually a patent to counter methods of spam filtering. It reduces the effectiveness of attempts to control spam. Here is evidence that a process is needed to reduce spam at the source rather than after it has been received.

U.S. Pat. No. 6,587,550 to Council et al, Jul. 1, 1003 provides for a method to charge a fee for unauthorized senders. The Council application in concerned with the source of spam, but its concept differs significantly from that of this application.

No further prior art in the concept of preventing the sending of spam has not been found.

### BACKGROUND OF THE INVENTION, OBJECTS AND ADVANTAGES

This object of this invention is to reduce the amount of spam being sent. In regards to a specified email addresses, the object is to prevent spam from being sent to that address. This is a significant advantage in that preventing the spam from being sent will reduce the overall load on the Internet. It will also reduce the amount of resources spent on handling spam once it is received. This advantage is achieved by convincing the spammer to not send spam where it is not wanted. A further objective is that the do not spam messages are delivered from numerous addresses located on numerous servers with differing locations. This will eliminate the possibility of a successful retaliation by a spammer.

### BRIEF SUMMARY OF THE INVENTION

A company is formed to implement the processes of this invention. The company creates a database of clients and spammers. When a client receives spam the client may choose to send a do not spam request to the spammer and a notification to the company. If the company continues to receive notices from clients the company may advise additional clients of these events. The number of clients notified by the company may increase as spamming events continue. Some of these additional clients may send do not spam requests to the spammer. The increasing load of do not spam requests may cause the spammer to utilize limited resources in managing these do not spam requests. Eventually the spammer will cease sending spam to the clients and the do not spam requests will cease.

### BRIEF DESCRIPTION OF THE FIGURES

FIG. 1. Depiction of company startup.

FIG. 2. Depiction of client enrollment.

FIG. 3. Depiction of company and client in response to spam.

FIG. 4. Depiction of spammer response.

### DETAILED DESCRIPTION OF THE INVENTION

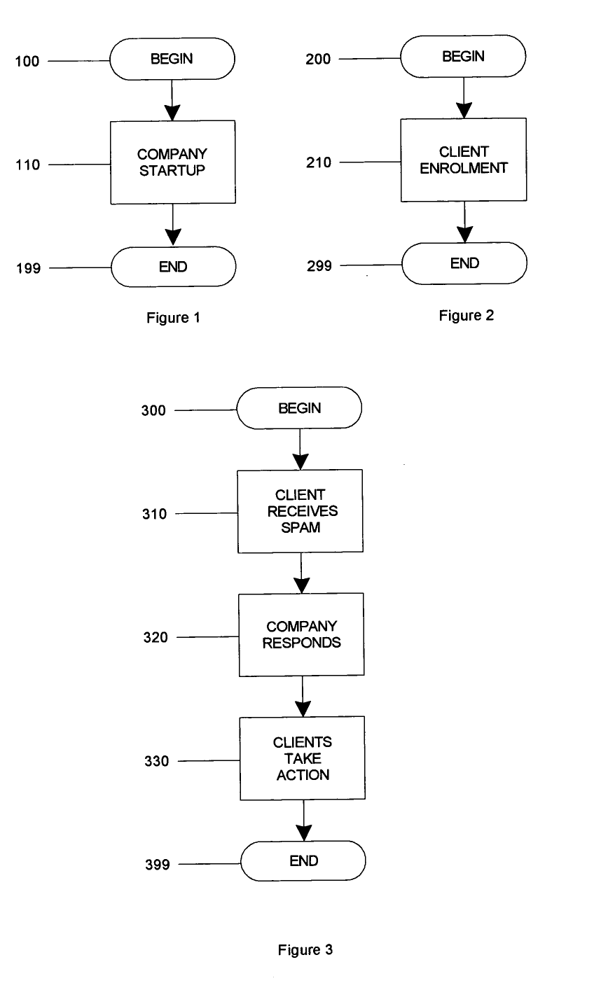

FIGS. 1 through 4 serve as a simple visual aid to the descriptions provided in the following text.

FIG. 1

FIG. 1 depicts the activities of starting a company. (The word company is used as previously defined) The process beings with entry point 100. Process 110 represents the multiple tasks required to start the company. The notable tasks begin with the company creating a database of Clients. This database will typically contain the email addresses for each client. Clients may be obtained through any combination of standard and non-standard methods to include commercial advertising, web sites, and person to person communications.

The company creates a spammer database. This database is used to track the behavior of selected spammers. The information contained in the spammer database is referenced in determining how the company responds to a spamming notification.

The company creates a web site. Via this web site, the general public may learn about the company, its purpose, and how it operates. Information about the client database, the spammer database, and company procedures are posted on the web site.

Exit point 199 depicts the completion of company startup procedures.

FIG. 2

FIG. 2 depicts the client enrollment procedure. Entry point 200 begins the procedure and process 210 represents the activities. Within process 210, a prospective client begins the activities by submitting a request to become a client. Included in this request is the email address or email address pattern the prospective client wishes to enroll. The company receives the request and examines the information from the client. The company sends a verification request to the prospective client. When the verification request is returned by the prospective client, the prospective client is enrolled as a client. The process ends with exit point 299.

FIG. 3

FIG. 3 depicts the activities that take place when a client receives spam. The activities of FIG. 3 will be repeated as necessary. Entry point 300 is the beginning point. Process 310 represents the client's activities on receipt of spam. When a client receives spam, the client may forward the spam to the company. Optionally, the client may send a do not spam request to the spammer. (see definition of do not spam request.)

Process 320 represents the activity within the company on receipt of a spam event notification from a client. The company receives the notification and determines if this is a new spammer or a repeat spammer. If the spammer is not currently registered in the spammer database, that is to say a new spammer, the company will make the appropriate entry into the spammer database detailing this spammer. If the company receives further notices of spamming, and the spammer was recently introduced into the database, then the company may select a grace period before taking further actions. The purpose of the grace period is to provide the spammer time to remove clients from their (the spammer's) email address list.

The company may be required to utilize some resources in determining if a spammer is a repeat spammer. The company may analyze the spam, the address of the sender, the client, and make a determination if the spammer is or is not a new spammer.

If the spammer is determined to be a repeat spammer, the company accesses the database and examines the spammer's history. The company applies an internal algorithm and calculates a spammer activity index. This index represents how often the spammer has been spamming clients. In general, as a particular spammer is determined to be responsible for larger numbers of spam events, that spammer's activity index will be raised.

The company may then apply another internal algorithm and select a list of clients from the client database. The number of clients selected may depend on the activity index of the spammer. In general, a higher activity index results in an increase in the number of clients selected. The company may then send a spammer activity notice to each of these clients. This notice will contain such information as the spammer's contact point, and the spammer's activity index.

Process 330 represents the activities of the client on receipt of a spammer activity notice. On receipt of the notice, the client may apply their own algorithm to the data in the spammer activity notice. The client may then send some number of do not spam requests to the spammer. In general, as the spammer's activity index is seen to be higher, the client may be encouraged to send additional do not spam requests to the spammer.

Termination point 399 represents the end of the response to a spam event.

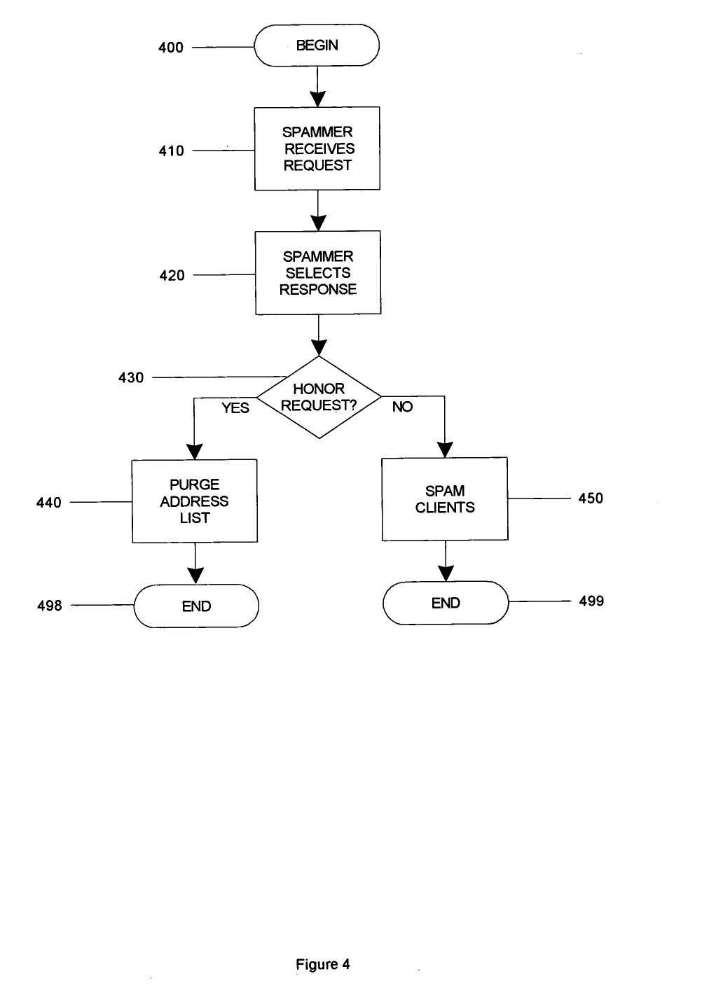

FIG. 4

FIG. 4 depicts the spammer's activities upon receiving a do not spam request. The process beings with entry point 400. Process 410 depicts the spammer's receipt of the do not spam request.

Process 420 represents the spammer's evaluation of the request. While the company and its clients have no direct control of the spammer, there are only two essential choices. The spammer's will either honor the request, or will not honor the request.

Decision point 430 depicts the spammers choice of actions as a result of the request. The desired outcome is for the spammer to honor the request. In that event the YES path is taken and process 440 depicts the activities of the spammer purging their address list of clients. End point 498 is the termination of this chain of events.

Process 450 depicts the spammer's activities when the choice is made to not honor the client's requests. In this event the NO path is taken and the spammer will continue to send spam to clients. End point 499 concludes only one cycle of a series of events. The activities of FIG. 3 and FIG. 4 may be repeated until the spammer honors the requests being made by the clients.

Interactions

When the spammer chooses to honor the do not spam request, the clients will receive reduced levels of spam and the traffic level of useless email on the Internet is reduced. This is the expected end result of this process.

However, this end result may not be immediately achieved. There may be some spammers that will reject the notice and even increase their spamming efforts. As clients receive spam and notify the company, the company may increase the spammer's activity index number. As that number increases, the count of individuals contacting the spammer and providing do not spam requests may increase. At some point the spammer is expected to determine that spamming clients results in more resources consumed than gained. The spammer will then purge the client list from their address list.

There may well be some spammers that claim the activities of the company are illegal. Clients have a first amendment right to tell others about spam they have received. Any given company has the same right to continue to spread the word about spam. Clients have the right to send do not spam requests to the spammer. The company and each client are making their own decisions as to how to respond to the spam.

Maintenance Procedures

The company may provide an additional capability to the spammer whereby the spammer can download a list of recent updates to the list of client addresses. The spammer can be given the capability of downloading this shortened list on a regular basis. This eliminates the need for each spammer to download the entire list of client email addresses on a regular basis.

Summary

Thus has been described a process that can be utilized to reduce the amount of spam sent through the Internet. In review, the essential components of this process are as follows:

A Company is established to pursue this process.

The company creates a database of clients and spammers.

Clients receive spam.

Clients contact spammer with a do not spam request.

Clients notify company of spam events.

Spammers are provided access to the database of client addresses.

The company notifies clients of spam events. The number of clients notified depends on the spammer's activity.

Notified clients may presume that a repeat spammer does not understand the do not spam request and may repeat the request until it is understood by the spammer.

The spammer has the choice of honoring the do not spam requests, or of enduring multiple do not spam requests from an enlarging quantity of clients. The spammer can terminate the do not spam requests simply by not sending spam to clients. In the final analysis, the spammer has control of these events.

1) A process to reduce the amount of spam being sent to clients, said process being comprised of means and processes for a company to,
a) create and populate one or more databases of clients, and
b) create and populate one or more databases of spammers, and
c) provide one or more processes for said clients to notify said company of spam events, and
d) provide one or more processes for said company to notify clients of said spam events, and
e) provide one or more processes and means for said spammers to discover the email addresses of client.

2) The process of claim 1 wherein a process is added for creating a company to implement said processes of claim 1.

3) The process of claim 1 wherein a process is added for creation of a web site for the purpose of assisting the implementation or operation of said processes of claim 1.

4) The process of claim 1 wherein a process is added to the process of claim 1 to provide said spammer with an ability to acquire a list of clients recently added to said database of clients.
